(19) United States
(12) Patent Application Publication
(10) Pub. No.: US 2012/0107048 A1
(43) Pub. Date: May 3, 2012

(54) IRRIGATION CONDUIT AND SYSTEM

(75) Inventor: Itzhak Agadi, Oranit (IL)

(73) Assignee: KIBUTZ YOTVATA, Hevel Eilot (IL)

(21) Appl. No.: 13/381,098

(22) PCT Filed: Jun. 27, 2010
(86) PCT No.: PCT/IL2010/000516

§ 371 Date: Dec. 28, 2011

(30) Foreign Application Priority Data
Jun. 28, 2009 (IL) 199590

(51) Int. Cl. A01G 25/00; B23P 17/00; E02B 11/00

(52) U.S. Cl. 405/45; 29/891

(57) ABSTRACT

An irrigation conduit for sub ground irrigation, methods for fabrication the conduit and irrigation systems comprising the same. The irrigation conduit comprises one or more elongated water-impermeable plastic strips joined to form a sleeve, wherein at least one of the strips comprises a plurality of water transmitting ceramic windows spaced along its length. The water transmitting ceramic windows are having an internal structure comprising vacuoles and a network of channels connecting between the vacuoles.

### BACKGROUND OF THE INVENTION

1. Field of the Invention

The present invention generally relates to agricultural irrigation. More specifically the present invention relates to a sub-ground irrigation conduit and irrigation system for continuously supplying water directly to roots of plants according to the water demand of the plants.

2. Discussion of the Related Art

The increasing gap between water demand and natural water resources, especially in arid areas, has prompted intense efforts directed at developing water-saving technologies, in particular in agriculture where water plays a crucial role.

One such water-saving technology is the drip, or trickle, irrigation method according to which water is distributed directly to roots of plants or trees at a slow rate, without substantial surface run off of the water, and with minimal evaporation of the irrigation water. To effect the slow application of irrigation water, the water distribution lines include emitters having extremely small orifices therein. As the soil surrounding the emitters becomes saturated an increase in hydraulic pressure is required for water discharge.

One type of irrigation-emitter is composed of a water-conduit labyrinth that reduces the water pressure of the distribution lines to a relatively low pressure that enables a slow discharge of water to the soil. As the soil moisture increases, the pressure required for continued discharge increases and the water flow is reduced until no further flow is obtained. To overcome blockage it is customary to irrigate in pulses rather than continuously so as to allow the soil surround the emitters to partially dry. The requirement of hydraulic pressure and pulse irrigation dictate the necessity of pressure pumps and computerized control systems, thus making drip irrigation systems expensive and relatively complicated to operate. Furthermore, it is believed that continuous irrigation is far better than periodic irrigation and that the resulting crop under continuous irrigation is exceedingly greater.

It is the general object of the present invention to provide a water-saving irrigation conduit and system of enhanced productivity and efficiency that maximizes crop output relative to input costs.

It is another object of the invention to provide an irrigation conduit and system that facilitates continuous irrigation to roots of plants at the amounts and rates dictated by the water demand of the plants.

Another object of the present invention is to provide an irrigation conduit and system that can be manufactured inexpensively, that is resistant to clogging, is easy to deploy and to operate and which once installed involves low maintenance cost and minimum labor.

More advantages and features will become apparent from the following description and drawings.

### SUMMARY OF THE PRESENT INVENTION

The present invention provides an irrigation conduit and irrigation system for continuously and efficiently providing water to roots of plants according to the water demand of the plants. The irrigation conduit comprises discrete water emitters spaced along its length, through which water is supplied to the plants not by applying high pressure to the water but by the negative pressure applied by the roots to draw water from the emitters (suction). The invention provides for a significant economization of water consumption with higher yields.

One aspect of the invention is an irrigation conduit for sub-ground irrigation comprising one or more elongated water-impermeable plastic strips which are joined along their elongated sides to form a sleeve, wherein at least one of the strips comprises a plurality of water transmitting ceramic windows spaced along its length. The water transmitting ceramic windows are having an internal structure which comprises vacuoles and a network of channels connecting between the vacuoles. The internal structure of the water transmitting ceramic windows is preferably similar to the internal structure of soil.

The irrigation conduit of the invention may be manufactured as a flat sleeve which is configured to assume and maintain an open tubular form when filled with water at a sufficient pressure. According to an embodiment of the invention, the irrigation conduit may comprise more than two plastic strips to form a conduit of a polygonal cross section.

Another aspect of the invention is an irrigation system for continuously and efficiently supplying water to roots of plants comprising at least one irrigation conduit of the invention buried in the soil adjacent to the plants' roots and at least one water reservoir of a constant water level in fluid communication with the irrigation conduit for providing hydrostatic pressure to said irrigation conduit. The irrigation system may further comprise a vertically movable pressure adjustment water container interposed between the water reservoir and the irrigation conduit.

Still a further aspect of the invention is a method for manufacturing an irrigation conduit, the method comprising the steps of: forming an elongated strip of water impermeable material; cutting openings along the length of the strip; attaching water permeable ceramic plates to the strip to cover the openings; and forming a sleeve from one or more strips by joining longitudinal edges of the one or more strips.

### BRIEF DESCRIPTION OF THE DRAWINGS

The present invention will be understood and appreciated more fully from the following detailed description taken in conjunction with the drawings in which:

FIGS. 1A and 1B are a partial perspective view and a partial planar view, respectively, of a fragment of an irrigation sleeve according to an embodiment of the invention;

FIG. 1C is a partial longitudinal cross section through the irrigation sleeve of FIG. 1A;

FIG. 1D is a blow up of region D in FIG. 1C, showing the internal structure of a water transmitting plate;

FIG. 2 is a perspective view of an irrigation conduit according to another embodiment of the invention;

FIG. 3 is a flow chart of a method for manufacturing the irrigation conduit of the invention;

FIG. 4 is a schematic illustration of an irrigation system according to an embodiment of the invention;

FIG. 5 is a schematic illustration of an irrigation system according to another embodiment of the invention.

FIG. 6A is an illustration of the irrigated zones formed in the vicinity of a conduit of the invention;

FIG. 6B is an illustration of a plant's root system in an irrigated zone;

FIG. 7 is a graphical representation of the water supply rate as function of time with and without plants;

FIG. 8 is a schematic graph showing the irrigation regime of the present invention compared to conventional drip irrigation.

### DETAILED DESCRIPTION OF THE PREFERRED EMBODIMENTS

The present invention provides a low-cost sub-ground irrigation conduit and irrigation system for continuously delivering water directly to roots of plants at a rate dictated by the water demand of the irrigated plants. Generally, the water conduit of the invention is a substantially flat sleeve comprising a plurality of water-transmitting windows spaced along its length at locations aligned with a row of crop plants. The water-transmitting windows are designed to supply water at substantially the same rate that water is taken by the plants, thus minimizing loss of water to the ground.

The irrigation system comprising the conduit of the invention operates under atmospheric or near atmospheric pressure with no need for pressure pumps, electrical power or computerized controlling systems, thus making its use beneficiary in developed as well as in under-developed countries and locations.

The water conduit of the invention is fabricated from two or more water-impermeable plastic or rubber strips connected to each other along their longitudinal edges by a water-tight seal to form a substantially flat hollow sleeve. Alternatively, the sleeve may be formed from one such strip folded lengthwise and having its longitudinal edges joined together. When filled with water at a sufficient pressure the sleeve opens out to provide a flow path for the irrigation water. The costs of manufacturing such a sleeve are significantly lower than the costs involved in the manufacturing of an open pipe that requires a large extrusion line apparatus which is far more expensive than an extruder of a flat sheet. Further, such a sleeve is more easily rolled, transported and stored than a conduit that has a permanent open cross-section.

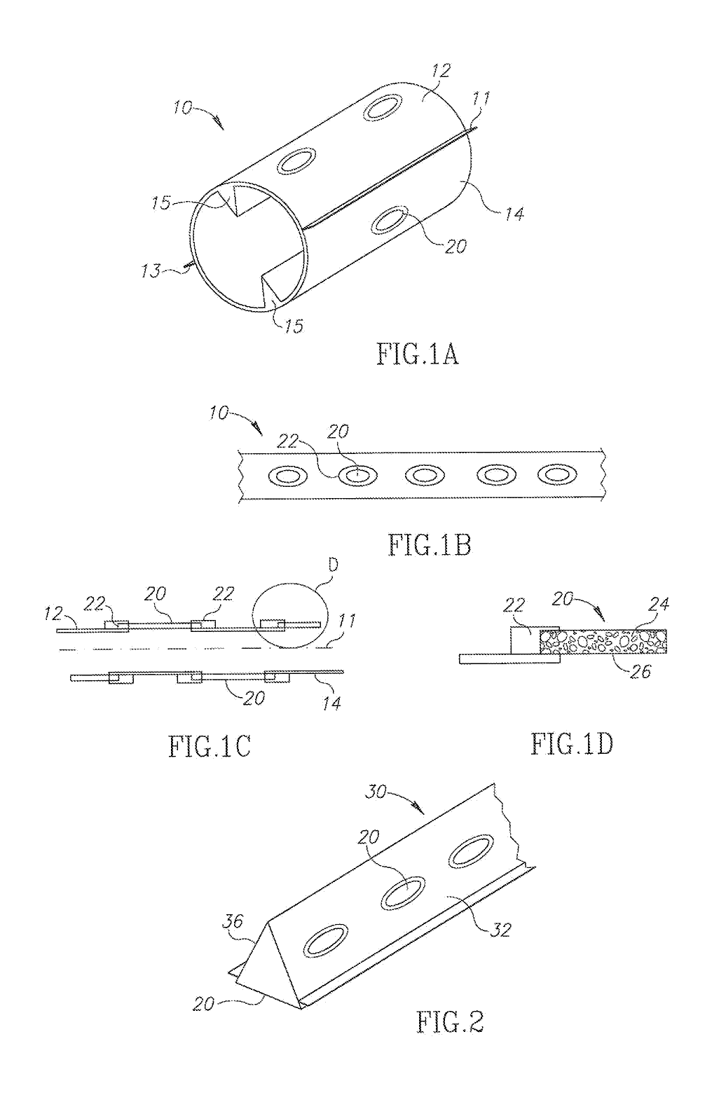

Referring to the drawings where like numerals refer to like elements, FIGS. 1A to 1C depict an irrigation conduit of the invention, generally designated 10, made of two flexible water-impermeable plastic strips 12 and 14. Strips 12 and 14 are joined to each other at their longitudinal edges by water-tight seams 11 and 13 to form a sleeve. Seams 11 and 13 can be formed by heat seal. Alternatively, the strips can be connected by any other method such as by adhesive, by laser welding, ultrasonic welding, etc. Strips 12 and 14 are fabricated from a polymeric resin. The material and the dimensions of the strips, as well as the geometry of the welded sleeve, are chosen such that the sleeve is sufficiently stiff to remain in open state and to resist compression. The strips may be made of plastic material that will undergo a permanent change of shape after being flexed outwardly (memory plastic). Alternatively, or additionally, the strips may comprise elongated ribs to enhance resistance to compression and deformation and to prevent collapsing. An example of triangular anti-collapsing ribs 15 is shown in FIG. 1. The elongated ribs may be extend continuously or discontinuously along the conduit and may be of any profile.

At least one of strips 12 and 14 is provided with openings 18 cut in the strips and covered by water-transmitting ceramic plates 20 to form discrete water transmitting emitters in the water impermeable conduit. Water-transmitting ceramic plates 20, of slightly larger dimensions than openings 18, are affixed to the strip by means of plastic frames 22, as best seen in FIG. 1C. Frames 22 are welded or heat fused to the strip by using any known welding or fusing technique such seal heat under pressure, laser. Alternatively, plates 20 may be affixed to the strip by any other technique, for example by using appropriate adhesive material, without using plastic frames.

In the embodiment shown in FIG. 1, strips 12 and 14 are joined to each other such that plates 20 are positioned on the external surface of the sleeve. Alternatively, the strips may be joined together in an inverted manner to have the plates positioned on the inner surface of the sleeve. It will be realized that the opposing rows of plates in the two strips may be arranged in a staggered (alternating) relationship as in FIG. 1 or aligned in parallel. It will be also realized that the plates may be arranged offset with respect to the longitudinal centerline of the strip and/or that more than one row of plates may be incorporated into one strip. The distance between adjacent plates is selected to be substantially equal to the typical spacing required between the plants for which the conduit is designed. The dimensions of the plate and its internal structure are designed to supply the necessary amount of water required for the particular plants for which the irrigation conduit is designed.

The conduit of the invention is not necessarily fabricated from two strips but may be fabricated from one strip sufficiently flexible to be folded and joined along its longitudinal edges. Yet according to other embodiments, the conduit may be made from more than two strips of flexible or stiff material joined together to form a sleeve of a polygonal cross section. FIG. 2 depicts a conduit 30 of a triangular cross section made of three strips 32, 34 and 36. Such a polygonal conduit may be more resistant to compression.

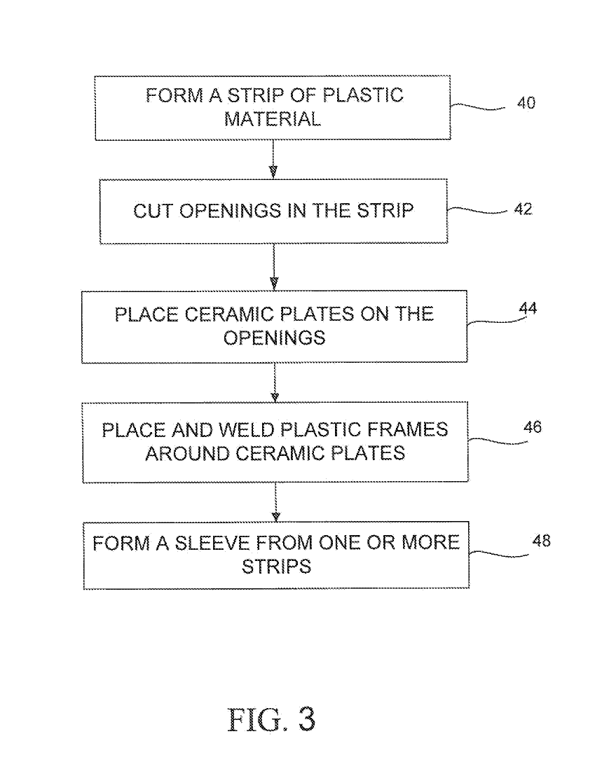

FIG. 3 is a flow chart of a method for manufacturing an irrigation conduit of the invention. In step 40 a plastic strip is formed and in step 42 openings are cut in the strip. The cut pieces may be shredded and recycled back to the hopper. The water-transmitting ceramic plates are then placed on the openings (step 44) followed by placing plastic frames around the ceramic plates and fusing them to the strip to affix the plates to the strip (step 46). In step 48, two or more strips with embedded ceramic plates are then joined together along their elongated edges, or alternatively only one such strip is folded lengthwise, to form the irrigation sleeve. It will be appreciated that the method described in FIG. 3 provides for manufacturing an irrigation conduit with discrete water emitters by a continuous process with no need to use connectors for connecting the discrete emitters to the conduit.

Water-transmitting plates 20, of preferably 1 to 10 mm thickness, are made of ceramic material that is having an internal structure, depicted in FIG. 1D, comprising vacuoles (space voids) 24 distributed substantially homogenously throughout the material and connected by a network of channels 26 that allow laminar flow between the vacuoles. When water flows through conduit 10, it enters plate 20 to fill the vacuoles. Thus, plates 20 become saturated with water. When buried underground, water diffuses from the saturated plates into the soil to form a zone of wetness around the plate. The average size of the vacuoles and channels, as well as the relative total void volume in the material, can be designed and selected according to the soil in which the conduit is to be buried. Generally, the average size of the vacuoles may vary from 0.1 to 3 mm while the channels' diameter is in the range of 1μ to 0.5 mm. The relative total void volume in the material may be from about 20% to about 60%. The plates can be of any size and shape according to needs and can be designed to transmit water at a rate that may vary from less than 1 ml/hour and up to more than 10 liter/hour. One alternative method of producing the ceramic material comprises mixing of clay with saw dust particles or other organic particles and eliminating the saw-dust (or other organic material or polymer grains) particles by exposing the hardened clay to extreme temperatures (typically in an oven) thus burning out the particles, leaving vacuoles in the material.

The internal structure of the ceramic plates is designed such that diffusion through the plate is not a limiting factor for water flow from the conduit to the soil. Preferably, the internal structure is similar to that of the soil where the conduit is to be used such that water diffuses through the plate at substantially the same rate it diffuses through the soil.

In use, the irrigation conduit is buried in the soil at about 10-15 cm below ground level such that water transmitting plates 20 are located near the roots of plants. The exact depth of the conduit may depend on the type of plants and their root system. When the inlet end of the conduit is connected to a source of water, the water diffuses through the ceramic windows and into the soil to form a wetness zone around each window. Preferably, the irrigation conduit of the present invention is used under a passive water supply that depends solely, or at least mainly, on hydrostatic pressure without using pressure pumps. The hydrostatic pressure is preferably adjusted to be equal or slightly higher than the capillary force of the soil.

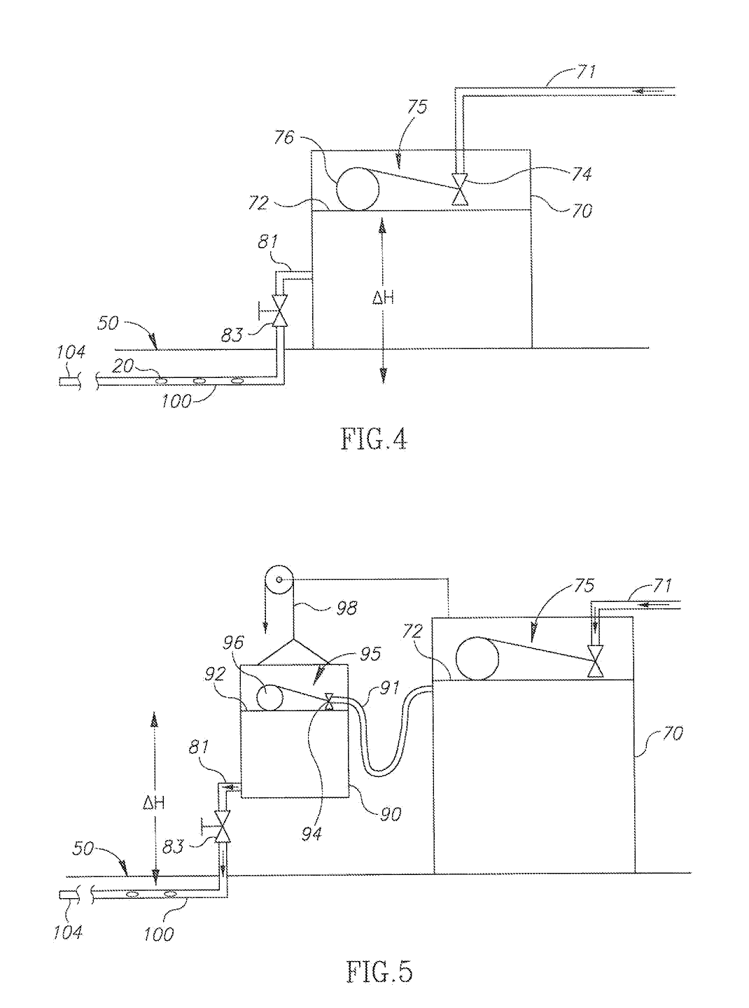

FIG. 4 depicts an embodiment of an irrigation system comprising a conduit 100 of the invention. Conduit 100, comprising water transmitting ceramic windows 20, is buried under ground level 50. The inlet end of conduit 100 is connected to a water supply system through valve 83 and its second end 104 is closed. Conduit 100 may be of a substantially circular cross section as of conduit 10 of FIG. 1 or of a polygonal cross section. In accordance with the invention, conduit 100 is not directly connected to a feed pipe of a water network. Instead, a water reservoir 70 is interposed between a water feed pipe 71 and the inlet end of irrigation conduit 100 for providing hydrostatic pressure. The other end 104 of conduit 100 is closed. Water reservoir 70 may be provided with two electrodes (not shown) immersed in the water for depositing calcite in the water tank to avoid clogging the in plates 20. The electric power for the electrodes may be supplied by an accumulator (not shown) to render the system independent of external power source.

Water level 72 in tank 70 is maintained constant at height ΔH above conduit 100 by means of a float control valve system 75 comprising valve 74 coupled to float 76. Valve 74 opens whenever the water level in tank 70 drops below water level 72 to allow water from pipe 71 to flow into the reservoir and shuts when the water level in the tank reaches level 72 again. Thus, but for water transmitting windows 20, the system is substantially a closed system maintained under a constant hydrostatic pressure determined by ΔH. The hydrostatic pressure is preferably adjusted to be equal or slightly higher than the capillary force of water transmitting windows 20 and the soil. A flow control 81 located on outlet pipe 81 allows for fine tuning of the pressure in irrigation conduit 100.

FIG. 5 illustrates a modified irrigation system which includes, in addition to water reservoir 70, a much smaller pressure adjustment water container 90 which is vertically movable by means of a pulley 98. Pulley 98 may be affixed to the upper or a side wall of water reservoir 70. Container 90 receives water from water reservoir 70 by means of a flexible pipe 91 that connects to water reservoir 70 below water level 72 and enters container 90 through float controlled valve 94 coupled to float 96. Float control valve system 95, comprising valve 94 and float 96, functions similarly to system 75 of water reservoir 70, to maintain a constant water level 92 in container 90. By moving container 90 up and down, the hydrostatic pressure in the system can be adjusted easily and quickly. Typically, ΔH is in the range of 20 to 150 cm.

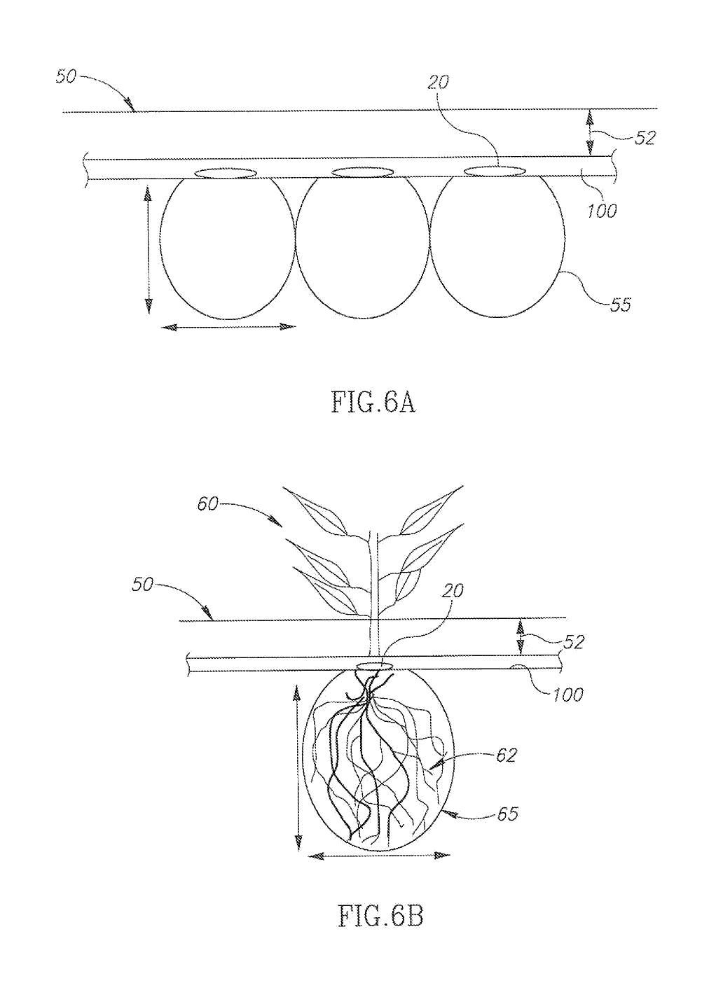

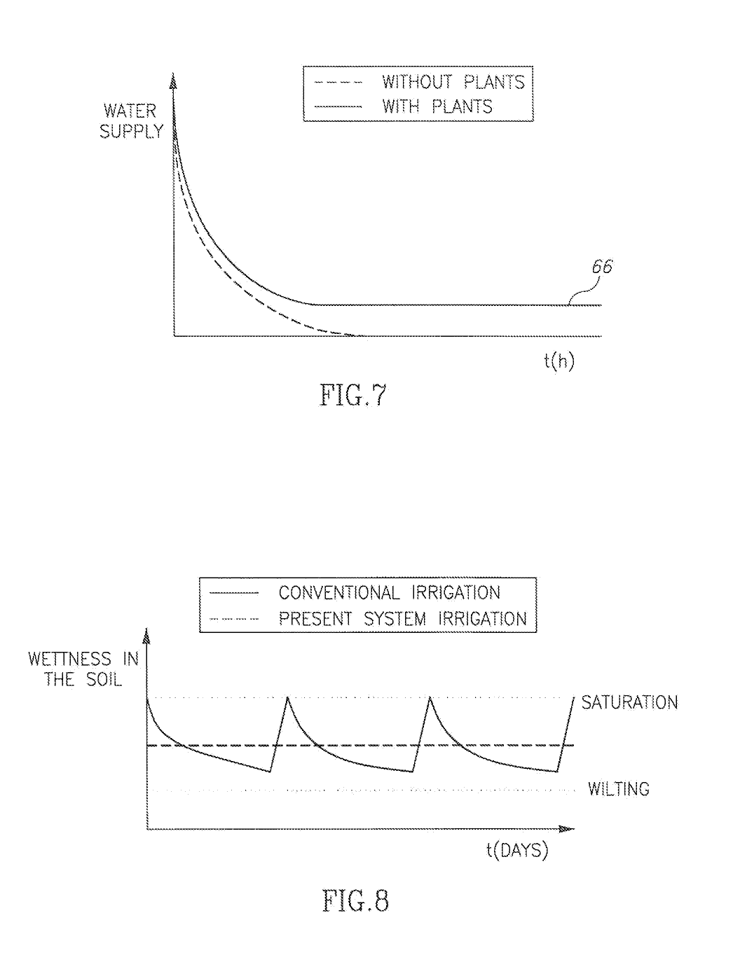

The water in conduit 100 leaks from ceramic window plates 20 at a slow rate to form a wetness zone 55 in the vicinity of each such window, as illustrated in FIG. 6A, while the upper layer 52 of the soil which is in direct contact with the air remains substantially dry. Thus, loss of water by direct evaporation from the ground is very small, practically negligible. The size of wetness zones 55 depends on the surface area of ceramic window 20 and on the hydrostatic pressure in the system. If there are no roots in the vicinity of conduit 100, water leaking from the windows will substantially cease after awhile to become negligible when an unstable equilibrium is established between the force exerted by the hydrostatic pressure and the capillary force of the soil, as depicted in broken line in FIG. 7.

FIG. 6B depicts a plant 60 having its root system 62 near a water transmitting plate 20. As root system 62 uptakes water from the soil, the water concentration in zone 65 decrease to create a water concentration gradient between roots 62 and window 20 which acts as a driving force to draw more water from the conduit through window 20. Thus, the rate and amount of water supply from conduit to the root system is dictated by the rate that water is taken by the roots, or it may be said that the plant is drawing water from the irrigation conduit on demand. The solid line in FIG. 7 represents water supply as function of time (hourly scale) in the presence of plants immediately after the water starts leaking into dry soil. After the initial decrease, the water supply reaches a substantially constant rate 66. It will be realized that according to the invention the water supply rate mimic the natural water demand of the plants and thus will be automatically adjusted to follow needs at different growing stages as well as to daily fluctuations in water consumption.

FIG. 8 schematically represents the wetness in the soil at the vicinity of the water transmitting window as function of time according to the present invention in comparison to a conventional drip irrigation method. According to the present invention, as the rate of water flow through window 20 substantially equals the rate of water taken by the plant, the degree of wetness in the soil around window 20 is almost steady with very small fluctuations. By contrast, in a conventional drip irrigation method, the wetness of the soil fluctuates periodically between a peak value close to full saturation where water dripping stops and a minimum value at which water dripping starts again.

It will be appreciated that since according to the present invention water supply is dictated by the irrigated plants, the amount of water that does not go directly to the plants is minimized. Preliminary experiments using an irrigation conduit and system of the invention for irrigating corn plants have shown that the water consumption with the proposed system is only a sixth of the water consumption in conventional existing dripper irrigation method with a yield which is about twice the yield with the conventional method, and that the growth period is reduced by about 30%. Taking into account all of these factors, the weighted water consumption per yield unit (kg or ton) is only about 8% compared to water consumption in existing methods, and the water saving with this proposed method is of about 90%.

It will be appreciated that although the present invention was described above with reference to field crops, the invention is not limited to this particular use but may be used for the irrigation of other plants, such as garden plants, house plants, flower pots, planters, window boxes etc, without departing from the scope of the invention.

It will be appreciated by persons skilled in the art that the present invention is not limited to what has been particularly shown and described hereinabove. Rather the scope of the present invention is defined only by the claims which follow.

1. An irrigation conduit for sub ground irrigation, the conduit comprising one or more elongated water-impermeable plastic strips joined along their elongated sides to form a sleeve wherein at least one of said one or more strips comprises a plurality of water transmitting ceramic windows spaced along its length, said water transmitting ceramic windows are having an internal structure comprising vacuoles and a network of channels connecting between said vacuoles.

2. The irrigation conduit of claim 1 wherein said conduit is manufactured as a flat sleeve and is configured to assume and maintain an open tubular form when filled with water at a sufficient pressure.

3. The irrigation conduit of claim 1 wherein the conduit comprises more than two plastic strips and wherein the conduit has a polygonal cross section.

4. The irrigation conduit of claim 1 wherein the internal structure of said water transmitting ceramic windows is similar to the internal structure of soil.

5. The irrigation conduit of claim 1 wherein the average diameter of said vacuoles is in the range of 0.1 to 3 mm diameter.

6. The irrigation conduit of claim 1 wherein the average diameter of said channels is in the range of 1μ to 0.5 mm.

7. The irrigation conduit of claim 1 wherein relative total void volume in the material is in the range of 20% to 60%.

8. An irrigation system for continuously and efficiently supplying water to roots of plants, the irrigation system comprising at least one irrigation conduit according to claim 1 buried in soil adjacent to the plants' roots and at least one water reservoir of a constant water level in fluid communication with said at least one irrigation conduit for providing hydrostatic pressure to said irrigation conduit.

9. The irrigation system of claim 8 further comprising a vertically movable pressure adjustment water container interposed between said at least one water reservoir and said at least one irrigation conduit.

10. A method for manufacturing an irrigation conduit, the method comprising the steps of:
forming an elongated strip of water impermeable material;
cutting openings along the length of said strip;
attaching water permeable ceramic plates to said strip to cover said openings; and
forming a sleeve from one or more strips by joining longitudinal edges of said one or more strips.
